(19) United States
(12) Patent Application Publication
(10) Pub. No.: US 2019/0208158 A1
(43) Pub. Date: Jul. 4, 2019

(54) Three-Dimensional Visual Display Including Directly Lit Diffusers

(71) Applicant: Plantronics, Inc., Santa Cruz, CA (US)

(72) Inventors: Jeremy Jacob D'Ambrosio, Soquel, CA (US); Jiefu Guo, Santa Cruz, CA (US); Jeffrey Michael Larson, Santa Cruz, CA (US)

(73) Assignee: Plantronics, Inc., Santa Cruz, CA (US)

(21) Appl. No.: 15/861,526

(22) Filed: Jan. 3, 2018

(51) Int. Cl. H04N 5/72; G06T 15/50; H04N 9/68; H04N 5/70; H04N 7/06

(52) U.S. Cl. CPC H04N 5/72; G06T 15/50; H04N 13/0257; H04N 11/00; H04N 5/70; H04N 7/06; H04N 9/68

(57) ABSTRACT

A display apparatus uses a LED array having a LED pixel pitch, having LED pixels emitting light with viewing angles θ. A transmissive diffuser panel is mounted with the LED array, having a directly lit, non-planar diffuser panel surface spaced away from the LED array by at least distance D. The distance D and the viewing angles θ being are effective to merge illumination from multiple LED pixels in the LED array on the directly lit diffuser panel surface. A controller is connected to the LED array having circuitry to control the LED array in response to image data to induce display via the diffuser panel of a time varying image with spatially varying colors and intensities.

### BACKGROUND

### Field

The present invention relates to 3D displays configurable for use in coordination with soundscaping.

### Description of Related Art

Open office environments are used in many businesses, where they can promote collaboration among workers while making efficient utilization of office space. A problem associated with open office environments relates to distraction that can be caused by activity of coworkers in the space.

Technologies have been developed to reduce distraction, by for example projecting sounds, such as so-called white or pink noise, into the environment that mask distracting sounds. However, noise masking techniques can become uncomfortable to workers in the space over time as they become aware of, or effected by, the masking sounds. Natural or biophilic sounds have been used in order to reduce the discomfort generated by white or pink noise. However, over time even natural sounds can become less effective in a soundscape environment.

Visual elements have been added to soundscape environments that can contribute to a sense of natural surroundings in an open office environment, in coordination with natural sounds. For example, high definition displays have been used to display water features or other natural scenes to serve as a visual justification for the presence of the sound. Such displays however create high definition images on a flat and shapeless form. Furthermore these devices are expensive. Also, completely defined, high definition visuals can create a distraction because they are not able to blend in with a viewer's surrounding environment, and they are not able to actively be altered without noticeable and unrealistic cuts or edits/loops. Also such displays have restrictive viewing angles and are cumbersome to mount in areas where a viewer could arrive with multiple angles of approach.

It is desirable therefore to provide technologies to improve the soundscape technology that can mask distractions in open office environments.

### SUMMARY

For the sole purposes of introduction of the description herein, a summary is provided in this section.

A 3D display technology is provided based on the use of arrays of LED pixels which directly light diffuser panels in order to produce tuned, diffused images having a 3D effect recognizable by the viewer. The resulting diffused, time varying images are both distinguishable and interpretable by a viewer. Embodiments of 3D displays as described herein allow for dynamic changes to the time varying images, such as colors and temperatures which vary over time producing visuals without distracting or noticeable edits in the ongoing time varying image.

A display apparatus is described that comprises a LED array, LED pixels in the LED array emitting light with viewing angles θ. A transmissive diffuser panel is mounted with the LED array, having a directly lit, non-planar diffuser panel surface spaced away from the LED array by at least distance D, the distance D and the viewing angles θ being effective to merge illumination from multiple LED pixels in the LED array on the directly lit diffuser panel surface. A controller is connected to the LED array having circuitry to control the LED array in response to image data to induce display via the diffuser panel of a time varying image with spatially varying colors and intensities.

In embodiments described herein, at least a portion of the directly lit, non-planar diffuser panel surface establishes lateral viewing angles when the apparatus is disposed as a ceiling mounted fixture, improving the experience for many angles of approach by a viewer.

In combination, the lateral viewing angles and the formation of diffused images on a directly lit diffuser panel surface create a three-dimensional effect arising from variations in colors and intensities in the diffused image, and the directly lit, non-planar surfaces of the diffuser panel.

Other aspects and advantages of the present technology can be seen on review of the drawings, the detailed description and the claims, which follow.

### BRIEF DESCRIPTION OF THE DRAWINGS

FIG. 1 is a simplified diagram of a soundscape system including a 3D display as described herein.

FIG. 2 is a perspective view of a “halo” shaped 3D display comprising a LED array with a non-planar diffuser panel having directly-lit laterally facing surfaces.

FIG. 3 is a cross-sectional view of components of a 3D display like that of FIG. 2.

FIG. 4 is an image of an LED module including an array of LED pixels suitable for use in 3D displays as described herein.

FIG. 5 illustrates spacing relationships among components of embodiments of 3D displays as described herein.

FIGS. 6-9 illustrate subassemblies at stages of manufacturing of a 3D display like that of FIG. 2.

FIG. 10 is a perspective view of a flat 3D display with upwardly curving edges including technology as described herein.

FIG. 11 is a cross-sectional view of a 3D display like that of FIG. 10.

FIGS. 12-13 illustrate subassemblies at stages of manufacturing of a 3D display like that of FIG. 10.

FIG. 14 is a perspective view of a 3D display including an elongated cylinder shaped viewing area.

FIG. 15 is an exploded view of a 3D display comprising a plurality of flat segments of a diffuser panel having laterally facing surfaces, including technology described herein.

FIG. 16 is a perspective view of the 3D display of FIG. 15.

### DETAILED DESCRIPTION

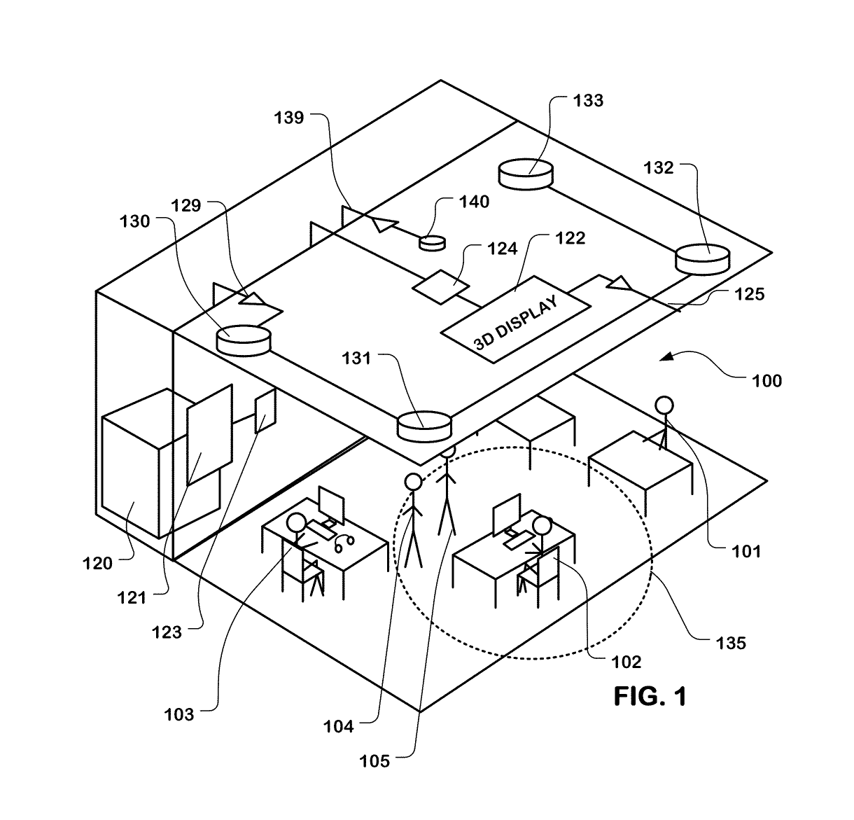

A detailed description of embodiments of the present invention is provided with reference to the FIGS. 1-16.

FIG. 1 illustrates an example of a soundscape system deployed in an open office environment. The open office environment includes workspace 100 in which a number of individuals 101, 102, 103, 104, 105 are present.

The soundscape system includes a computer system 120 which can execute soundscape server programs in this example which manage operation of the components of the soundscape system. In other examples, computer system 120 can be an on-premises network node, and include a communication link to a remote network node which executes soundscape management services, by which the soundscape is coordinated using cloud-based soundscape server programs accessed for example via the Internet.

As illustrated in FIG. 1, a zone of intelligibility 135 surrounds each of the individuals in the open office environment workspace 100. For example, if the individuals 104 and 105 are having a conversation, then that conversation could distract the individual 102. The soundscape system is configured to reduce the zone of intelligibility.

A plurality of speakers 130, 131, 132, 133 is arrayed around the workspace 100, in the ceiling in this example is used to generate a soundscape sound. An audio driver 129 drives the soundscape tracks to produce the sound provided by the soundscape server via the computer system 120. The sound can comprise biophilic or natural sounds, such as flowing water and a gentle breeze through leaves.

The system includes a wall mounted display 121 which plays video content provided by a video player 123, which is in turn coupled to the computer system 120. The display 121 can be characterized as a digital window.

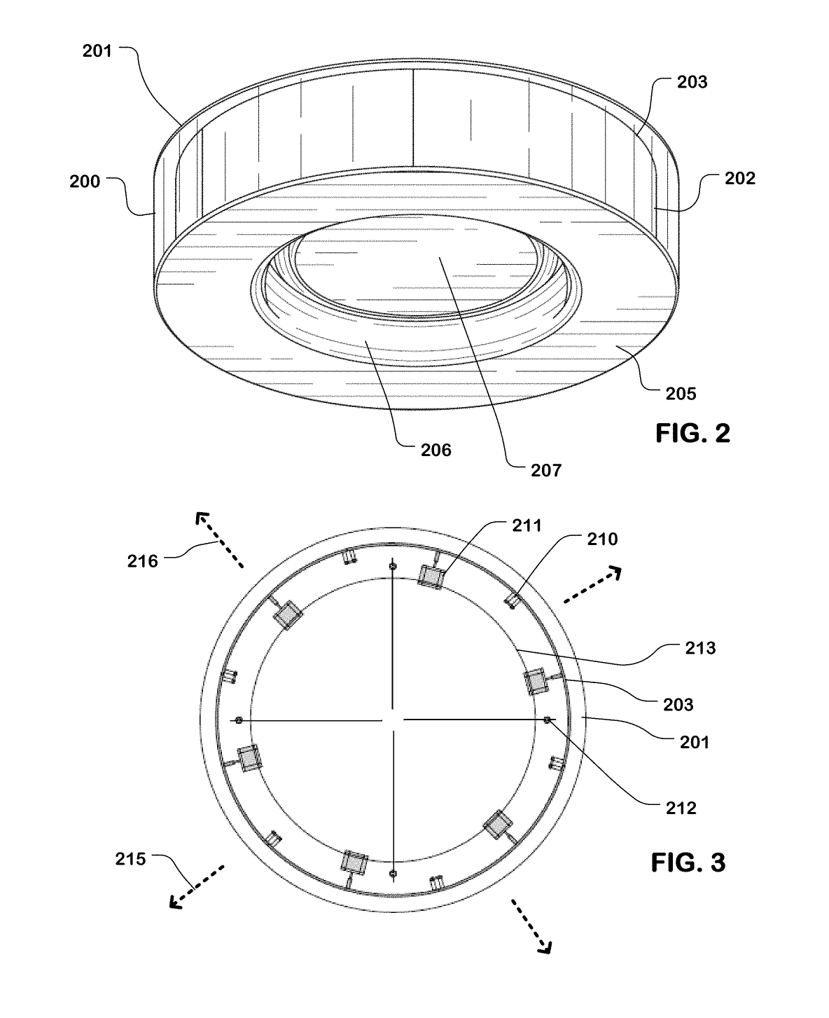

The system includes ceiling mounted 3D display 122 which plays video content provided by a video player 124, which is in turn coupled to the computer system 120. The 3D display 122 can be coupled to a source of image data that causes generation of interpretable time varying image suggestive of a source of the sound in the environment. The displayed time varying image can comprise images interpretable as flowing water for example, or leaves moving in a gentle breeze. As described below, the time varying image need not reproduce an image with high definition, but rather can comprise a diffused image in which variations in intensity and color evoke 3D effects for a viewer. Examples of 3D displays which can be used as display 122 in the illustrate example, are described below with reference to FIGS. 2, 10 and 14 that comprise non-planar diffuser surfaces on which the diffused time varying image can be generated.

The source of image data can be an on premises server 120, a cloud-based server accessed via the internet, or other source. There may be a plurality of ceiling mounted 3D displays coupled via an amplifier on line 125 to the video player 124. A controller for the 3D display is coupled to a source of image data that causes generation of an interpretable time varying image suggestive of a natural source of the sound in some embodiments.

In this example, a distraction sensor 140 is coupled via an amplifier on line 139 to the computer system 120, the output of which can be utilized by the soundscape server programs to adjust and change the soundscape audio track and video content being executed at any particular time.

A soundscape as illustrated in FIG. 1 can transform an open office into an intelligent, multi-sensory experience that facilitates teamwork and enables workers to maintain focus. Natural sounds and images suggestive of sources of the sounds can be used that dynamically adjust to changing noise levels and integrate with complementary visible elements that satisfy an innate human desire to feel close to nature while relieving stress and rejuvenating the senses.

FIG. 2 is a perspective drawing of a 3D display having a “halo” shape. Changes in aspect ratio of this form can be implemented, including extending its height to a “barber pole” like shape. See FIG. 14 for example.

The 3D display includes a transmissive diffuser panel 201 (shown as clear in the figure for the purposes of showing its relationship to the underlying structure), which is mounted with an LED array 203. The LED array 203 is arranged on a cylindrical form. The LED array has a surface 202 and emits light in a radial pattern to directly light a back surface of the transmissive diffuser panel 201. The transmissive diffuser panel 201 has a cylindrical diffuser panel surface that is directly lit by the LED array.

The 3D display shown in FIG. 2 is configured as a ceiling mounted fixture, and includes a decorative cover 205 on the lower surface, having a “washer” shape, with a recessed region 207 coupled by a curved transition element 206 to provide an enclosed structure for components of the 3D display. The time varying image data is formed by direct lighting of the non-planar, laterally facing diffuser panel surface 200 by the LED pixels 202.

FIG. 3 is a cross-section view of one embodiment of a 3D display like that of FIG. 2. In the example of FIG. 3, the transmissive diffuser panel 201 has a circular cross-section. It is spaced away from the LED array 203, which is disposed on a cylindrical form. The LED array 203 comprises a plurality of curved LED panels (six in this example) connected to form a cylinder by fittings 210. The curved LED panels are mounted on a base cylinder form 213 by stanchions 211. Support pins 212 are arrayed around the base cylinder form, for connection to cables or posts to support ceiling mounting of the fixture. When mounted as a ceiling fixture, the cylindrical form of the LED array will have an axis orthogonal to a plane, which plane is referred to herein as a plane of the ceiling. Thus, in embodiments in which the fixture is mounted on a nonplanar ceiling or a ceiling which is not orthogonal to a floor, the plane of the ceiling for the purposes of this description is defined by the axis of the cylindrical form of the LED array, as the actual orientation relative to the ceiling and the floor may vary depending on a variety of architectural and aesthetic parameters.

A time varying image can be produced on a non-planar diffuser panel surface spaced away from and concentric with the cylindrical form of the LED array. This allows production of a diffused image having radial viewing directions (e.g. 215, 216), which face laterally relative to a plane of a ceiling on which this fixture is mounted.

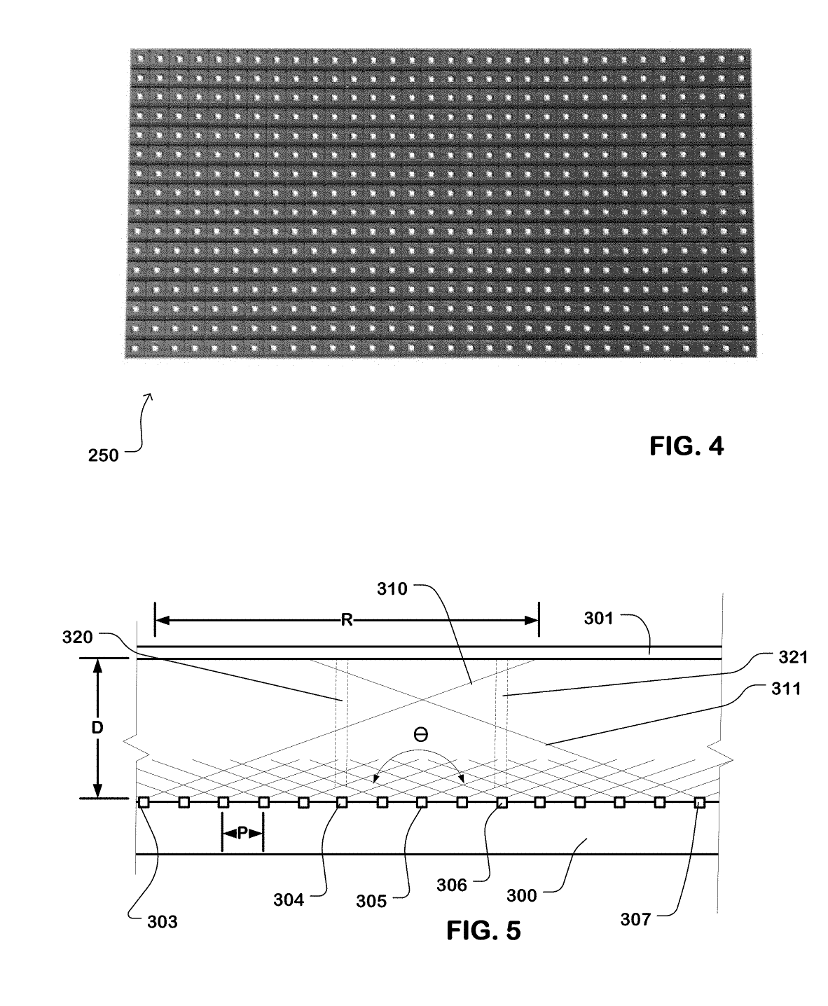

FIG. 4 is an image of an LED module 250 showing an array of LED pixels (white spots) on a background panel. The panel can be configured on a cylindrical form, or a planar form. Representative LED modules are commercially available with display driver circuitry and power supplies. Suitable LED modules are available from, among others, Shenzen Unit LED Co. Ltd., 3 Building, Sanlian Industrial Park, Shiyan, Baoan, Shenzhen, China, and LedControlCard.com.

As can be seen, the LED modules arrange LED pixels in an array having a horizontal pitch and a vertical pitch (pixel pitches), which are equal in the illustrated example. For representative embodiments, the horizontal and vertical pitches can be 8 to 10 mm, although a wide range of pitches are available and can be adopted for particular implementations.

Each LED pixel can comprise colored LEDs. In a representative system, each LED pixel includes red, green and blue LEDs, and can be used to generate colored light in the RGB color space. A representative LED module can be operated with a brightness of greater than 1200 cd/m² (candela per meter squared), although in the production of time varying images maximum brightness may not be utilized.

The LED pixels in the LED modules emit light with relatively broad viewing angles, where a viewing angle is defined as the angle relative to a surface normal to the LED at which light intensity is 50% of its maximum value. The viewing angle can be different in horizontal and vertical directions in some embodiments. In representative embodiments, LED pixels having a viewing angle of 50° to 80° might be utilized.

LED modules such as that shown in FIG. 4 are typically used for producing images for viewing at very long ranges. At close ranges, the individual LED pixels are distinguishable by the viewer.

As described herein, the diffuser panel is disposed over the LED array so that it is directly lit by the LED pixels in the array. Also, the diffuser panel is spaced away from the LED array by a distance D sufficient to diffuse the light emitted by the LED array so that the individual LED pixels are not distinguishable by a viewer (no twinkle from individual LED pixels), or otherwise do not detract from the image being produced. The diffuser panel however must be close enough to the LED array however that the direct light on any given point on the panel does not include contributions from so many LED pixels as to wash out definition of an image represented by the image data. Thus the spacing must be close enough that the diffused image produced by the direct lighting can be interpreted by the viewer. For example, a diffused image can be produced that is suggestive of a source of sound in a soundscape environment as discussed above.

FIG. 5 illustrates a section of an LED module and a diffuser panel, illustrating the distance D between the LED array and the diffuser panel, and its relationship to the pixel pitch and viewing angles of the LED pixels. In FIG. 5, and LED module 300 includes an array of LED pixels (e.g., 303, 304, 305, 306, 307) spaced away by a distance D along a surface normal vector of the LED module 300, from a diffuser panel surface of a diffuser panel 301. The diffuser panel surface is configured to be directly lit by the LED module 300.

In FIG. 5, the module 300 is illustrated as a planar module in order to simplify the figure for the purposes of the description. To support a 3D display like that of FIGS. 2 and 3, the module 300 and the diffuser panel 301 will have a curvature. In both planar LED module and curved LED module embodiments, the distance D can be uniform across at least a majority of the LED array which illuminates the directly lit, diffuser panel surface.

The LED pixels on the module 300 are arranged in an array having a pixel pitch P, where the pixel pitch is the spacing from the center of one LED pixel to the center of its adjacent LED pixel along one of the X and Y axes of the array.

In FIG. 5, divergence of the light emitted by the LED pixels is illustrated by ray trace lines (e.g. 310, 311). Only the ray trace lines 310 and 311 are drawn all the way from the corresponding LED pixel 303, 307, to the directly lit diffuser panel surface of the diffuser panel 301 in order to reduce crowding in the figure. At LED pixel 305, it can be seen that the ray trace lines diverge by an angle θ (symmetrical about the surface normal for the pixel 305 in this example). The angle θ is two times the viewing angle of the corresponding LED pixel for the purposes of this description, where the viewing angle is defined as the angle where the measured light intensity is 50% of its maximum value. For a representative embodiment, with a viewing angle of about 70°, the angle θ is about 140°.

As illustrated, the pixel 303 has a right side ray trace 310 which intersects the directly lit diffuser panel surface at a position that is to the right of pixel 303. Likewise, the LED pixel 307 has a left side ray trace 311 which intersects the directly lit diffuser panel surface at a position to the left of pixel 304.

A zone of illumination around a particular LED pixel has an area which is a function of its viewing angle θ/2 and the distance D. Assuming that the zone of illumination is circular, the zone of illumination will have a radius R equal to about D*tan(θ/2) for a flat directly lit diffuser panel surface. For a curved directly lit diffuser panel surface, the radius R of the zone of illumination will project on the directly lit diffuser surface, making a slightly different radius on curved surface.

For a pixel pitch P of about 10 mm with a flat LED module, it is found that the distance D in a representative embodiment must be about 27 mm plus or minus about 10% in order to maintain an interpretable image with a diffuser panel comprising a textured polycarbonate sheet 0.125 inches thick, while substantially eliminating the twinkle from individual LED pixels in the array, where twinkle is defined as areas of intensity on the diffuser panel that are recognizable by a view as emission from a particular LED.

It can be seen in FIG. 5, that a region on the diffuser panel surface immediately above an individual LED, such as the regions 320, 321 for the LED pixels 304 and 306, falls within the zone of illumination defined by the viewing angles of many pixels. For example with a pixel pitch of about 10 mm and a distance D of about 27 mm, it with a viewing angle θ/2 of 70°, the radius R of the zone of illumination is about 27 tan(70°) or 74.2 mm. Thus a region, such as region 320, will be illuminated by LED pixels that are disposed in the LED array within a zone of illumination, assuming a circular zone, having an area (πR²) of over 17,000 mm².

For a pixel pitch of about 8 mm with a curved LED module, such as shown in FIG. 3 where the outside radius of the cylindrical form of the LED module 11.25 inches, it is found that the distance D must be about 38 mm±10% in order to maintain an interpretable image with a diffuser panel comprising a matte polycarbonate film 0.020 inches thick, while substantially eliminating the twinkle from individual LED pixels in the array.

The distance D can be determined experimentally for a given environment in which the 3D display is to be deployed, and for particular implementations of the LED module and diffuser panel. It is found that the distance D should fall within a range that is relatively narrow in order to maintain the quality of having an interpretable image without twinkle from individual LED pixels. In some embodiments, an effective distance D is between two times and five times the LED pixel pitch. In some embodiments, an effective distance D is selected so that D*tan(θ/2) is greater than five times the LED pixel pitch on at least one axis of the LED array. In some embodiments, the distance D is tuned so that time varying images regions of contrasting intensity produce a three dimensional image effect. In some embodiments, the distance D is tuned so that time varying images produced do not include twinkle, but remain interpretable by human observers.

Transmissive diffuser panels used in 3D displays as described herein can comprise a variety materials. The materials are chosen to diffuse the illumination from the LED array so that the individual LED pixels blur and blend to make an interpretable viewing experience. Representative materials can include acrylic sheets, polycarbonate sheets, polycarbonate films which have sanded or textured surfaces, impregnated with light diffusing additives, or both textured and combined with light diffusing additives. Diffuser panel materials can be cut, formed and molded into complex shapes, including cylindrical shapes as described herein. Diffuse panel materials are available commercially from a variety of sources, including Covestro AG, Kaiser-Wilhelm-Allee 60, 51373 Leverkusen, Germany; Excelite, 908RuiQi Building 668#, Fengting Street S Suzhou, China; and Curbell Plastics, Inc., 7 Cobham Drive, Orchard Park, N.Y.

According to embodiments of a 3D display as described herein, the pixel pitch of the LED pixels, the distance D between the LED module and the directly lit surface of the diffuser panel, and the viewing angle in combination are effective to merge illumination for multiple LED pixels in the LED array on the directly lit diffuser panel surface, and can be tuned to achieve the interpretable, 3D image effects described herein.

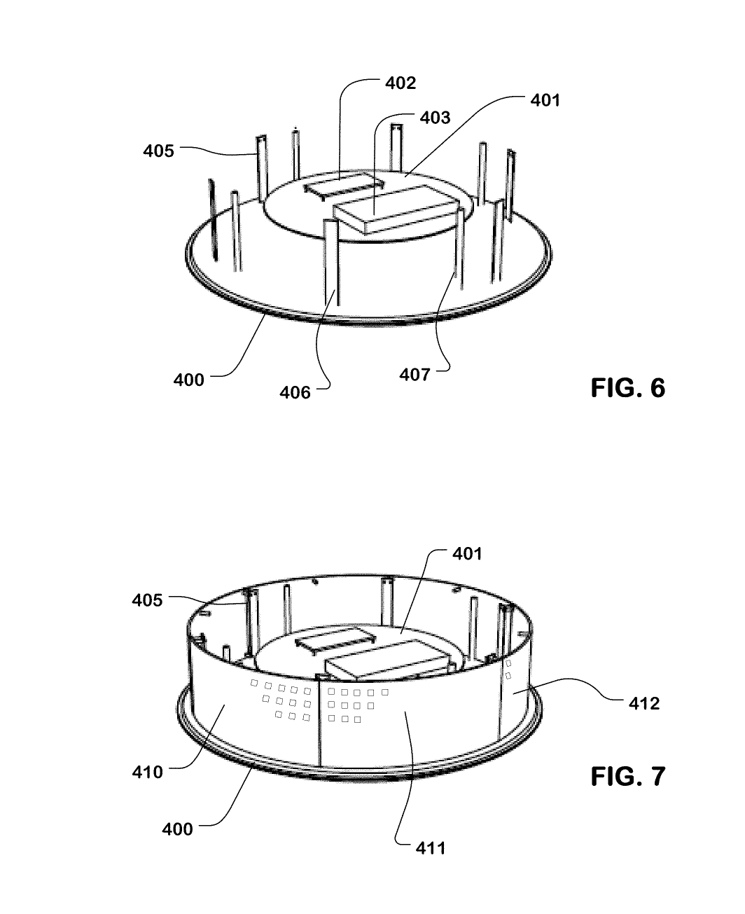

FIG. 6-9 illustrate assembly of a 3D display like that of FIG. 2. In FIG. 6, a subassembly is illustrated including a base panel 400 on which a plurality of stanchions (e.g. 405, 406, 407) are disposed. An electronics board 401 is mounted on the base panel 400. Electronic components including a controller card 402 and a power supply 403 are mounted on the electronics board. The controller card 402 is coupled to a source of image data as discussed above, by corded or wireless connections as suits a particular implementation. The controller card 402 includes a controller connected after completion of the assembly to the LED array. The controller card 402 comprises circuitry to control the LED array in response to image data. As a result, the controller induces display via the diffuser panel of a time varying image with spatially varying colors and intensities.

FIG. 7 illustrates a subassembly after addition of six curved LED modules (e.g. 410, 411, 412). The LED modules are coupled to corresponding stanchions on the base 400, to form an LED array arranged on a cylindrical form. Electronic connections (not shown) are made between the electronics on the electronics board 401 and the individual panels.

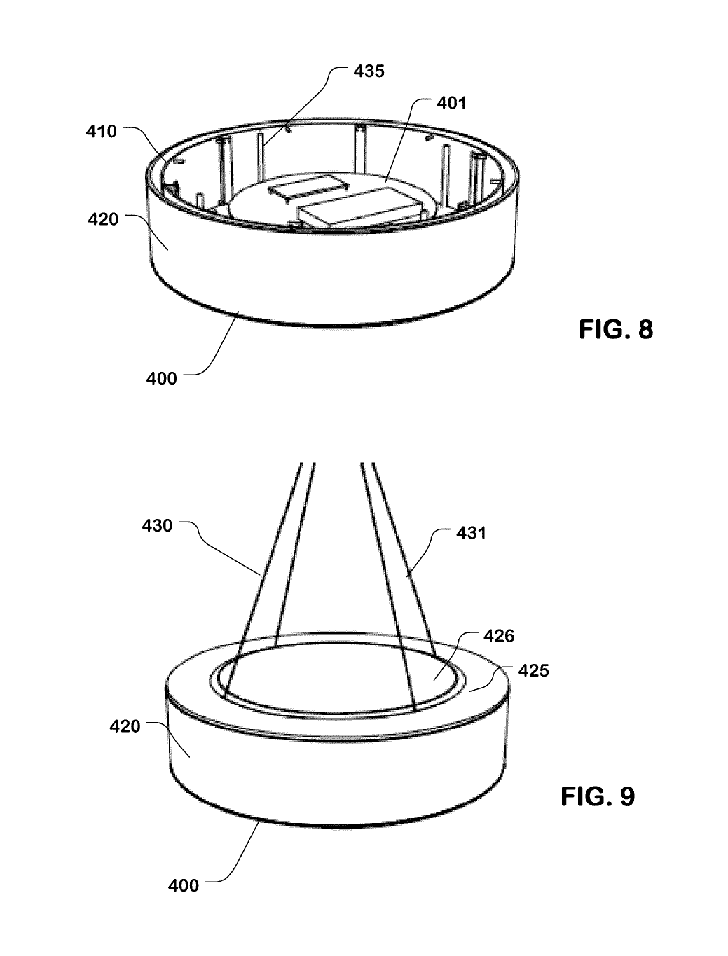

FIG. 8 illustrates a subassembly after addition of a cylindrical diffuser panel 420 on the base 400. As can be seen, the diffuser panel 420 is disposed concentrically with the cylindrical form of the LED array, and spaced away from the LED modules (e.g. 410) of the cylindrical LED array by the distance D as described above. Posts (e.g. 435) are connected to the base 400, in order to configure the fixture for ceiling mount.

FIG. 9 illustrates the completed assembly after addition of a cover panel 425 and 426. Cables or posts 430, 431 are coupled to the posts (e.g. 410) and used for mounting the fixture on a ceiling. The transmissive diffuser panel 420 includes a directly lit surface that is nonplanar, and is viewable from directions laterally relative to the plane of the ceiling.

The assembly of FIG. 9 is a display apparatus, comprising a ceiling mount fixture for mounting relative to a plane of a ceiling. It includes a LED array mounted on a cylindrical form on the ceiling mount fixture, the cylindrical form having an axis orthogonal to the plane of the ceiling. A transmissive diffuser panel is mounted with the LED array, having a directly lit, cylindrical diffuser panel surface, concentric with the cylindrical form, and spaced away from the LED array and facing laterally relative to the plane of the ceiling. A controller connected to the LED array is included, which controls the LED array in response to image data to induce display via the diffuser panel of a time varying image with spatially varying colors and intensities.

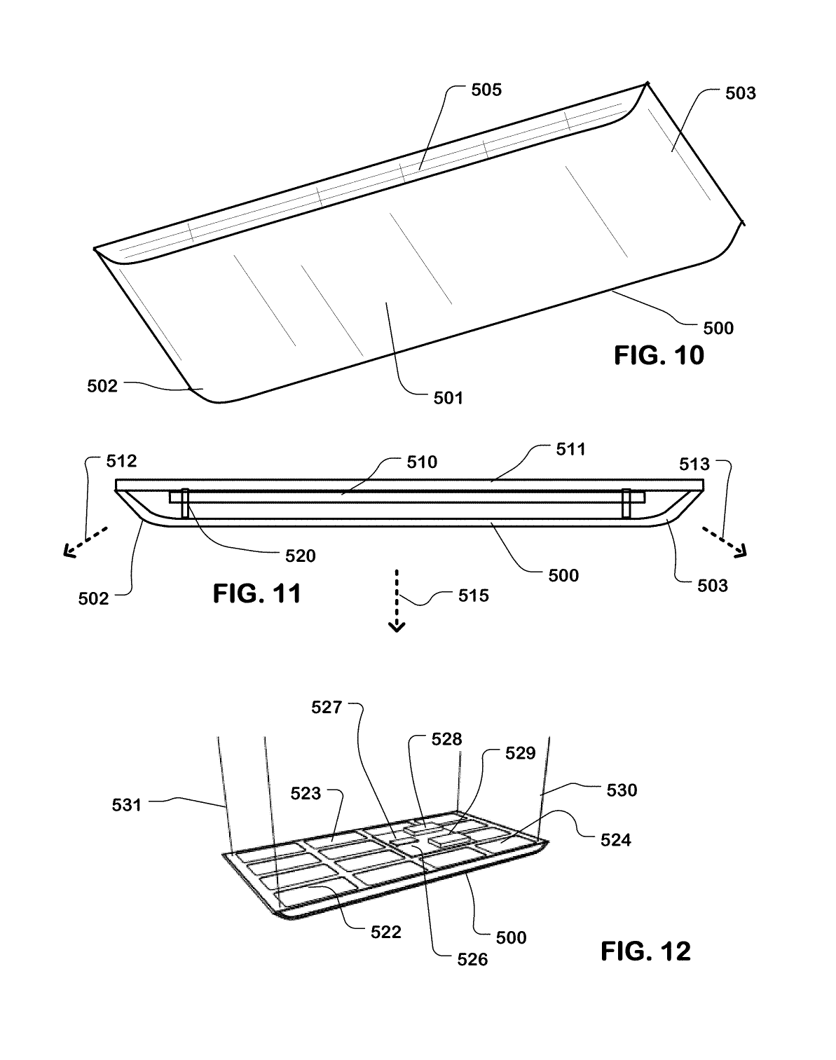

FIG. 10 is a perspective view of a 3D display having a flat shape with laterally curved sides, illustrating an alternative embodiment of a 3D display. In this embodiment, the diffuser panel as a surface 501 which is substantially planar over a major portion of its illuminated area. The diffuser panel surface is straight along a line 500, and curves upwardly towards the plane of the ceiling, when considered as a ceiling mounted fixture. The side panel 505 can obscure and LED array mounted inside the fixture. The diffuser panel includes areas 502, 503, which are directly lit by the underlying LED array, but face laterally relative to the plane of the ceiling.

FIG. 11 illustrates a cross-section of a 3D display like that of FIG. 10. As can be seen, the LED array 510 is disposed on a flat or planar form 511. The diffuser panel 500 includes laterally facing perimeter regions 502 and 503. The diffuser panel 500 is spaced away from the LED array 510 by posts (e.g. 520) in this example, which can be small enough and few enough as so as to not because distracting shadows on the directly lit surface of the diffuser panel 500.

In the illustrated example, the LED array 510 is disposed in an array of modules so that the LED pixels are spaced away from the directly lit surface of the diffuser panel 500 by the distance D, over at least a major region parallel to the planar mount, portion of the diffuser panel 500. LED pixels near the edges of the LED array illuminate the curved perimeter regions 502 and 503 of the diffuser panel to a degree effective to enhance a three-dimensional effect of the time varying image. An image created on the directly lit surface of the diffuser panel 500 is viewable both vertically (on arrow 515) and laterally (on arrows 512, 513).

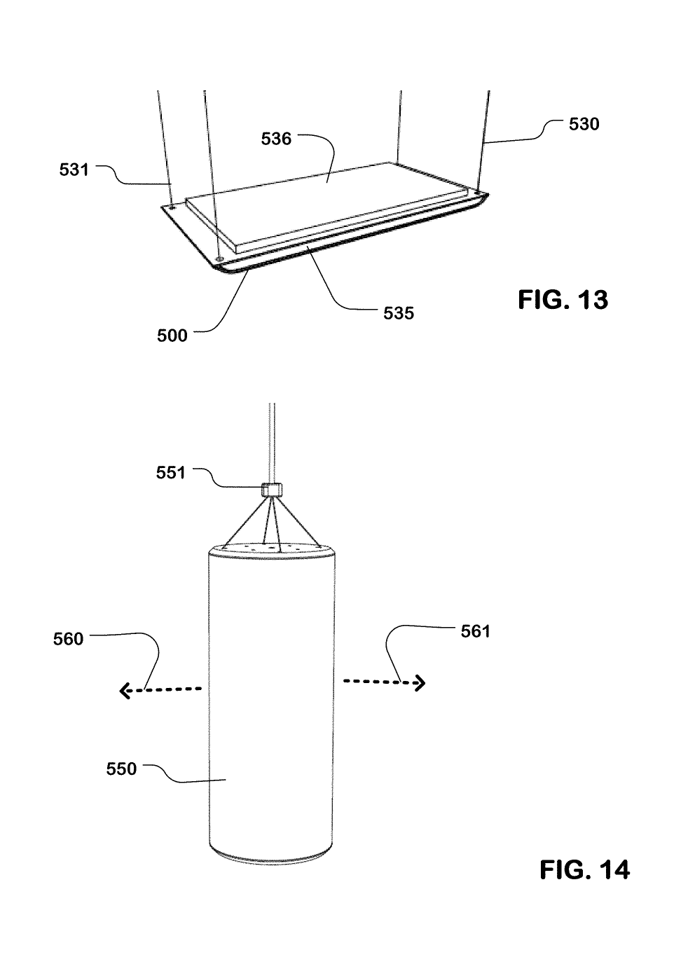

FIGS. 12 and 13 illustrate subassemblies of a flat 3D display like that of FIG. 10 configured as a ceiling mounted fixture. In FIG. 12, the diffuser panel 500 is coupled to a set of LED modules (e.g. 522, 523, 524) that are coupled to a planar form, and provide LED pixels facing the inside surface of the diffuser panel 500. An electronics board 526 is mounted on the set of modules, and includes a controller card 527 and one or more power supplies 528, 529. The controller card 527 includes a controller having circuitry to drive the LED modules as discussed above with respect to the embodiment of FIGS. 6-9.

A plurality of posts, or cables, (e.g. 530, 531) are connected to the base to provide for mounting the fixture on a ceiling.

FIG. 13 shows the fixture configured for ceiling mount, with a backplate cover 536, and side panel 535.

The assembly of FIG. 13 is a display apparatus, comprising a ceiling mount fixture. A LED array is mounted on a planar form on the ceiling mount fixture, the planar form parallel to the plane of the ceiling. A transmissive diffuser panel is mounted with the LED array, having a directly lit, diffuser panel surface spaced away from the LED array, the directly lit, diffuser panel surface having a major region parallel to the planar form and curved perimeter regions facing laterally relative to the plane of the LED array (which can be parallel to a plane of the ceiling). A controller is connected to the LED array which controls the LED array in response to image data to induce display via the diffuser panel of a time varying image with spatially varying colors and intensities.

FIG. 14 is a perspective drawing of a 3D display with a cylindrical transmissive diffuser panel 550, directly lit by a LED array to produce images that are viewable laterally. It can be assembled as discussed above in connection with the embodiment of FIGS. 6-9. A LED array (not shown) is disposed within the diffuser panel 550, and spaced away by a distance D to enable production of time varying, diffused images as discussed above, which are interpretable, and can be made without twinkle. The 3D display of FIG. 14 is configured as a ceiling mounted fixture having mounting structure 551, and providing for lateral viewing from directions 560, 561. The radius of the cylindrical diffuser panel 550 can be about 4 to 6 inches for example, and the vertical height can be 16 to 20 inches for example. Of course other dimensions are possible as suits a particular installation.

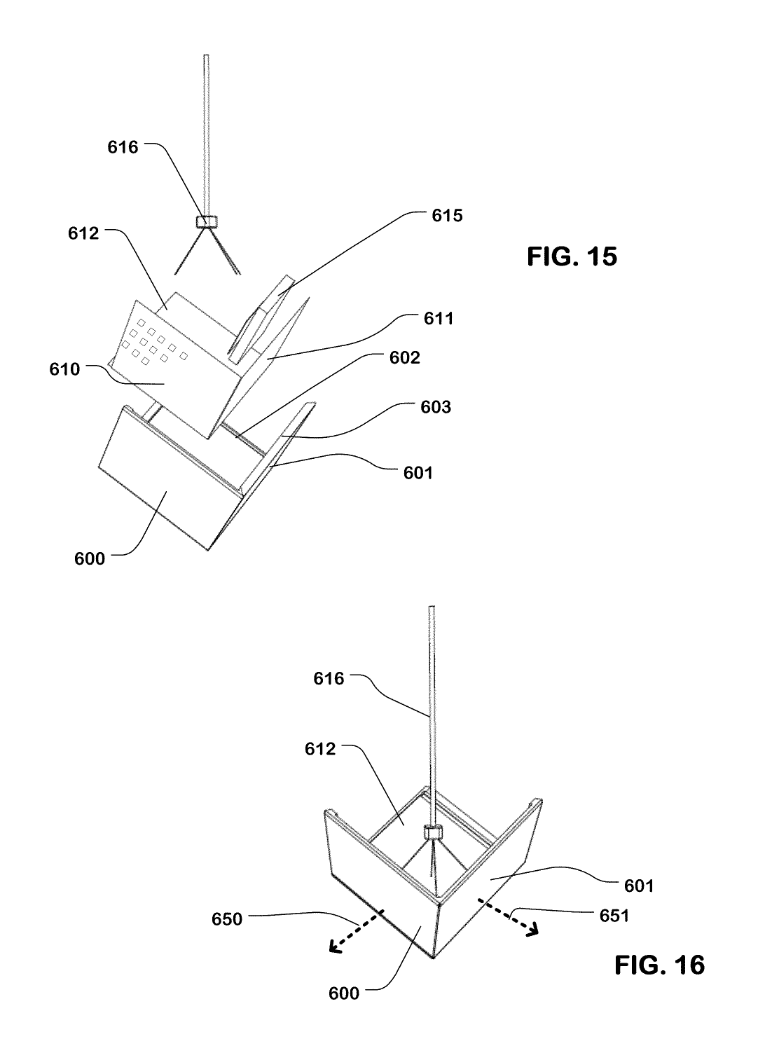

FIG. 15 and FIG. 16 are an exploded view and a perspective view of yet another embodiment of a 3D display. Referring to FIG. 15, a diffuser panel comprises a three sided prism shape having subpanels 600, 601, 602 mounted on a frame 603. A LED array comprises matching panels 610, 611, 612, which is configured to be disposed inside and spaced away from the diffuser subpanels (600, 601, 602) by the distance D, and to directly light the diffuser subpanels as discussed above. An electronics board 615 is mounted on the LED panels, housing a controller card and a power supply for example. A ceiling mount 616 comprising a set of cables is attached to the structure, and configured for ceiling mounting of the fixture.

A perspective view of the three sided prism embodiment is shown in FIG. 16. The diffuser panel includes laterally facing subpanels (e.g. 600 and 601). The LED panel 612 is secured to the diffuser panels. The ceiling mount 616 is secured to the structure. As a result, lateral viewing from directions 650, 651 can be provided.

The fixture of FIG. 16 includes a plurality of panels arranged to face in different directions, and the directly lit, non-planar diffuser panel surface includes a plurality of regions spaced away by at least distance D from corresponding panels in the plurality of panels.

It will be appreciated that a variety of three-dimensional shapes can be utilized to provide for lateral viewing of a 3D display based on directly lit diffuser panels as described herein.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A display apparatus, comprising:
a LED array, LED pixels in the LED array emitting light with viewing angles θ;
a transmissive diffuser panel mounted with the LED array, having a directly lit, non-planar diffuser panel surface spaced away from the LED array by at least distance D, the distance D and the viewing angles θ being effective to merge illumination from multiple LED pixels in the LED array on the directly lit diffuser panel surface; and
a controller connected to the LED array having circuitry to control the LED array in response to image data to induce display via the diffuser panel of a time varying image with spatially varying colors and intensities.

2. The apparatus of claim 1, configured as a ceiling mounted fixture which orients the directly lit, non-planar diffuser panel surface relative to a plane of a ceiling, and the directly lit, non-planar diffuser panel surface includes areas facing laterally relative to the plane of the ceiling.

3. The apparatus of claim 1, wherein the LED array is arranged on a cylindrical form, and the directly lit, non-planar diffuser panel surface is cylindrical.

4. The apparatus of claim 1, wherein the LED array is disposed on a planar form, and the directly lit, non-planar diffuser panel surface has a major region parallel to the planar mount and curved perimeter regions.

5. The apparatus of claim 1, wherein the LED array includes a plurality of panels arranged to face in different directions, and the directly lit, non-planar diffuser panel surface includes a plurality of regions spaced away by at least distance D from corresponding panels in the plurality of panels.

6. The apparatus of claim 1, wherein the LED array has a LED pixel pitch, and the distance D being between two times and five times the LED pixel pitch.

7. The apparatus of claim 1, wherein the LED array has a LED pixel pitch, so that D*tan(θ) is greater than five times the LED pixel pitch.

8. The apparatus of claim 1, the distance D being tuned so that time varying images produced do not include twinkle, but remain interpretable by human observers.

9. The apparatus of claim 1, the distance D being tuned so that time varying images regions of contrasting intensity produce a three dimensional image effect.

10. The apparatus of claim 1, wherein the LED array includes a set of RGB color LEDs in each LED pixel.

11. The apparatus of claim 1, configured for use in a soundscape environment in which a sound is produced in the environment, and wherein the controller is coupled to a source of image data that causes generation of an interpretable time varying image suggestive of a source of the sound.

12. A display apparatus, comprising:
a ceiling mount fixture for mounting relative to a plane of a ceiling;
a LED array mounted on a cylindrical form on the ceiling mount fixture, the cylindrical form having an axis orthogonal to the plane of the ceiling;
a transmissive diffuser panel mounted with the LED array, having a directly lit, cylindrical diffuser panel surface, concentric with the cylindrical form, and spaced away from the LED array and facing laterally relative to the plane of the ceiling; and
a controller connected to the LED array which controls the LED array in response to image data to induce display via the diffuser panel of a time varying image with spatially varying colors and intensities.

13. The apparatus of claim 12, wherein the LED pixels in the LED array have an LED pixel pitch and viewing angles 0, and the directly lit, cylindrical diffuser panel surface spaced away from the LED array by at least distance D between two times and five times the LED pixel pitch.

14. The apparatus of claim 13, so that D times tan(θ) is greater than five times the LED pixel pitch.

15. The apparatus of claim 13, the distance D being tuned so that time varying images produced do not include twinkle, but remain interpretable by human observers.

16. The apparatus of claim 13, the distance D being tuned so that time varying images regions of contrasting intensity produce a three dimensional image effect.

17. The apparatus of claim 12, wherein the LED array includes a set of RGB color LEDs in each LED pixel.

18. The apparatus of claim 12, configured for use in a soundscape environment in which a sound is produced in the environment, and wherein the controller is coupled to a source of image data that causes generation of an interpretable time varying image suggestive of a source of the sound.

19. A display apparatus, comprising:
a ceiling mount fixture for mounting relative to a plane of a ceiling;
a LED array mounted on a planar form on the ceiling mount fixture, the planar form parallel to the plane of the ceiling;
a transmissive diffuser panel mounted with the LED array, having a directly lit, diffuser panel surface spaced away from the LED array, the directly lit, diffuser panel surface having a major region parallel to the planar form and curved perimeter regions facing laterally relative to the plane of the ceiling; and
a controller connected to the LED array which controls the LED array in response to image data to induce display via the diffuser panel of a time varying image with spatially varying colors and intensities.

20. The apparatus of claim 19, wherein the LED pixels in the LED array have a LED pixel pitch and viewing angles θ, and the directly lit, diffuser panel surface is spaced away from the LED array by at least distance D between two times and five times the LED pixel pitch.

21. The apparatus of claim 20, wherein D times tan(θ) is greater than five times the LED pixel pitch.

22. The apparatus of claim 20, the distance D being tuned so that time varying images produced do not include twinkle, but remain interpretable by human observers.

23. The apparatus of claim 20, the distance D being tuned so that time varying images regions of contrasting intensity produce a three dimensional image effect.

24. The apparatus of claim 19, wherein the LED array includes a set of RGB color LEDs in each LED pixel.

25. The apparatus of claim 19, configured for use in a soundscape environment in which a sound is produced in the environment, and wherein the controller is coupled to a source of image data that causes generation of an interpretable time varying image suggestive of a source of the sound.
